(19) United States
(12) Patent Application Publication
(10) Pub. No.: US 2009/0315760 A1
(43) Pub. Date: Dec. 24, 2009

(54) HYBRID TRACKING CONTROL SYSTEM AND METHOD FOR PHASED-ARRAY ANTENNAE

(75) Inventors: Seyed Pedram Mousavi Bafrooei, Waterloo (CA); Seyed Hamidreza Jamali, Waterloo (CA); Mohammad Fakharzadeh Jahromi, Toronto (CA); Kiarash Narimani, Waterloo (CA); Mircea Hossu, Mississauga (CA); Hamidreza Bolandhemmat, Kitchener (CA); Safieldin Safavi-Naieni, Waterloo (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(73) Assignee: Intelwaves Technologies Ltd.

(21) Appl. No.: 12/130,727

(22) Filed: May 30, 2008

Related U.S. Application Data
(60) Provisional application No. 60/924,856, filed on Jun. 1, 2007.

(51) Int. Cl. H01Q 3/00; G01S 7/40

(52) U.S. Cl. 342/174; 342/377; 342/368; 342/359

(57) ABSTRACT

A hybrid control algorithm for low profile phased-array antennas, consisting of a gyro control and electronic beam-forming, operates to track the satellite. The antenna arrangements form a spatial phased-array capable of being rotated mechanically both in azimuth and elevation planes by the aid of step motors. An RF detector monitors the received RF power and provides a feedback signal to the control algorithm. Based on the monitored signals, provided by RF detector and gyros, the processing unit operates, under suitable algorithms, to home on and track the desired satellite. The arrangements can be mounted on a vehicle to provide TV and broadband internet signal to the user on the move.

(Applicant claims the benefit of U.S. Provisional Application Ser. No. 60/924,856 filed on Jun. 1, 2007)

### BACKGROUND OF THE INVENTION

1. Field of the Invention

This invention relates to a tracking phased-array antenna system and to a method of beam-forming for the system, which is mounted on a mobile platform for use in tracking a target using an algorithm to maximize a level of signal received from the target without prior knowledge. This invention further relates to a method of eliminating the effects of gyro drift and high level noise and to a hybrid tracking algorithm.

2. Description of the Prior Art

In recent years there is an increasing demand for satellite broadcasting and communications in vehicular stations, such as cars, SUVs, bus, train, ship and aircraft beyond a fixed station. Vehicle mounted antennas are one of the most critical parts in providing the satellite services for moving vehicles. In addition to satisfying the basic requirements such as high gain and directivity, the vehicle mounted antenna should be capable of satellite tracking for fast moving conditions. Tracking the satellite in a moving vehicle is one of the essential elements of a mobile satellite antenna. Cars on the roads are not only moving forward, but changing lanes, going over bumps, and turning corners and all that motion must be compensated for by the antenna so that it can remain locked on to the satellite signal.

Previous methods, such as monopulse tracking, canonical scan and step tracking, and electronic beam squinting have been used. Generally, these methods can be categorized in two types of open-loop tracking and closed-loop tracking. The former technique uses a sensor, while the latter employs the signals received from a satellite. A hybrid tracking scheme combining both methods, will outperform either one alone.

Conventionally, the satellite tracking can be divided into two modes, i.e., initial satellite search mode and a tracking mode. A re-initialization mode can also be foreseen for the cases when the satellite signal is lost for a period of time due to blockage or signal shadowing, and an initial search is required to retain the lock. In the initial satellite search mode, which is hereinafter called “Homing”, the antenna beam is pointed towards the desired satellite by means of rotating the antenna or its beam. In the tracking mode the antenna tracks the satellite by compensating for the vehicle movement. In this mode, it is likely that the satellite tracking system loses track of the satellite direction during signal outage, e.g., when the satellite is temporarily blocked by a large object or when the vehicle passes through tunnels. To alleviate this problem and retain the satellite lock, the homing mode should be reperformed. To differentiate this mode from initial homing it is called Re-Homing.

Different antenna technologies are in use in satellite broadcasting or communication systems. Generally, these technologies can be categorized into several main types. One type utilizes reflector antennas with full mechanical steering. However, because of restrictions on dimensions (especially height) and aerodynamics, this type is not suitable for moving vehicles. Another type is phased-array antenna with electronic beam scanning in both azimuth and elevation planes which contains plurality of radiating elements. The electronic scan capability of the phased-array antennas is a proper feature that can be utilized to implement the hybrid tracking methods in different applications, such as satellite communications.

A variety of hybrid satellite tracking methods, using the combination of a mechanical tracking and an electronic beam controlling, have been appeared in the literature. In T. Wantanabe, M. Ogawa, K. Nishikawa, T. Harada, E. Teramoto, and M. Morita, “Mobile antenna system for direct broadcasting satellite,” IEEE Antennas and Propagation Society International Symposium, 21-26 Jul. 1996, Page(s);70-73 vol.1., the satellite tracking is performed by using both the gyroscope signal and the received signal level. While the signal level is higher than a preset threshold, the tracking is done using only the gyro signals. If the signal level drops below the preset threshold level, then the tracking controller estimates a fluctuation of the received signal level by slightly rotating the array antenna right and left, and adjusts the beam direction as the received signal level goes up. This technique is applied only for azimuth tracking and the elevation tracking is omitted due to large elevational beam width.

In Soon-Ik Jeon, Young-Wan Kim, and Deog-Gil Oh, “A new active phased array antenna for mobile direct broadcasting satellite reception,” IEEE Trans. on Broadcasting, Volume 46, Issue 1, March 2000, Page(s):34 40, a tracking method is applied for a phased-array antenna system used to provide Ku-band satellite broadcasting mobile service. This method uses a one-dimensional electronic beam scanning in elevation and mechanical scanning in azimuth. In phase of satellite tracking the system is operated by the squinted beam tracking with respect to main beam. Two-level phase-shifters are used to make the main beam as well as the squint beam. The squint beam rotates around the main beam by adding some phase to the main level phase. Similar ideas are applied in Seong Ho Son, Soon Young Eom, and Soon Ik Jeon, “A novel tracking control realization of phased array antenna for mobile satellite communications,” The 57th IEEE Semiannual Vehicular Technology Conference, VTC 2003-Spring, 22-25 Apr. 2003, Page(s);2305-2308 vol.4 and Ung Hee Park, Haeng Sook Noh, Seong Ho Son, Kyong Hee Lee, and Soon Ik Jeon, “A novel mobile antenna for Ku-band satellite communications,” ETRI Journal, Volume 27, Number 3, June 2005, Page(s); 243-249 for the tracking control of the phased-array antennas for the shipboard station in X-band satellite communication and multimedia communications Ku-band geostationary satellite, respectively.

U.S. Pat. No. 5,537,122 (July, 1996) discloses an approach for the array antenna system with target tracking capability. In this approach, a hybrid control method is used based upon a Beam-Switch Tracking (EST) and an angular rate-sensor. The BST generates combined azimuth motor control signal based upon a BST signal and a high pass filtered rate-sensor output. This combined tracking method keeps the angular rate of the array antenna around an azimuth axis to nearly zero even at the absence of the received signal from the target.

Another approach is illustrated in U.S. Pat. No. 6,191,734 (February, 2001) which discloses a control method for performing attitude control of a vehicle-mounted antenna for receiving a satellite broadcasting. The said method employs a hybrid tracking technique that performs tracking using an electronic beam in an elevation direction while performing mechanical tracking in an azimuth direction. In this approach the electronic scanning is performed by the use of a secondary tracking beam.

A further example is U.S. Pat. No. 6,989,787 (January, 2006) which discloses a hybrid tracking technique in which both one-dimensional phase array control of the elevation is mixed with one-dimensional mechanical control of azimuth and a double beam satellite tracking method and an electronic direction detection method are used.

Previously, electronic beam steering is performed only for elevation and in most systems, a secondary beam is utilized for this purpose. Previous systems do not receive a strong signal from the satellite, or they lose the signal too easily and have too much difficulty in finding the signal again.

### SUMMARY OF THE INVENTION

It is an object of the present invention to provide a hybrid tracking method for low cost phased-array antenna systems based upon combination of an electronic beam-forming and mechanical steering. Although the invention is described in the context of a satellite TV reception device, the basic principles apply to any tracking system for any target, which employs phased-array antennas and used for various applications such as mobile satellite Internet access or Radar system.

In accordance with one aspect of the present invention, there is provided a low profile phased-array antenna system for satellite TV reception by users on the move. The phased-array antenna system comprises: a radom, a rotating part for receiving the satellite signals while rotating for satellite tracking, and a fixed part connected to the rotating part by a rotary joint, for supporting the rotating part and providing the power supply. The rotating part comprises a plurality of array antennas for receiving a signal from a satellite; a plurality of active channel modules for performing low noise amplification; a plurality of the reception connecting means; a plurality of analog voltage controlled phase shifters for shifting the received signal to a desired phase; a power combiner circuit for combining the output signals of the phase shifter modules; a conversion means for down-converting the combined received signal to a desired intermediate frequency; a satellite signal detection module for extracting the satellite ID; a RF module for monitoring the received signal level and providing a signal path to the satellite signal detection module; angular rate-sensors for sensing the angular rates in azimuth and elevation directions; step motors for rotating the rotating part in the azimuth plane and the antenna arrangements in the elevation plane; a main control unit for performing the hybrid tracking control algorithms; a motor control unit for providing proper commands to step motors; motor drivers for driving the step motors; and a plurality of digital-to-analog converters for providing the analog control voltages to phase shifters.

In accordance with another aspect of the present invention, there is provided a hybrid control algorithm used for the satellite-tracking mobile-vehicular low profile phased-array antenna system. The satellite-tracking control system consists of a combination of a gyro control and an electronic beam-forming. The antenna platform consists of a rotating plate in azimuth which can rotate more than 360 degree in any direction (clockwise and counter clockwise) and several antenna arrangements which can rotate in elevation direction around their traversal axis. Two rate gyros, connected to the antenna platform, provide most of the information required to keep the antenna pointed at the satellite while the vehicle moves about, after an acquisition procedure determines the initial satellite direction. The use of electronic beam-forming enables the antenna to respond much faster and prevents the mechanical system from being engaged all the time. The innovative electronic beam-forming allows for fast tracking of the satellite when the car is on a rough road or experiences some other vibrations.

The present hybrid satellite tracking method comprises of (a) initializing of hardware and starting homing process if the system switch is ON, (b) performing a hybrid tracking after the homing is completed until the satellite is lost due to temporarily blockage, (c) setting a timer and entering the re-homing process for retaining the satellite lock after the timer is expired, (d) performing periodic calibration for updating the required parameters and compensating the parameter variation due to environmental conditions and aging. The step (d) is performed independently From steps (a), (b) and (c).

In step (a), upon switching on the antenna system, the control system starts initializing the Homing parameters, and then enters to the Homing mode. In this mode the antenna platform performs an initial satellite search using combined mechanical and electronic techniques. When the RF power exceeds a threshold level the Satellite ID is then obtained from the based-band DVB signal. The threshold level is determined adaptively in the course of system operation. Once the extracted ID coincides with the desired satellite ID, then the homing process is completed and the control system enters the tracking mode.

In the homing mode the search starts with a preset phase-shifters setting, obtained from the calibration and the history of the system. This setting includes the initial values for the control voltages of the phase-shifters. Using two step motors, the mechanical search is performed in both azimuth and elevation. Upon exceeding a RF power threshold, the control system extracts the satellite ID and compares it with the desired satellite ID. As the power of the received signal depends on the environmental conditions and the vehicle position, the mentioned RF power threshold should be set adaptively. The adaptive threshold setting and checking of the good RF power level are achieved by performing moving averaging for the signal power with two different averaging window sizes. The corresponding moving averages are named short term averaging and long term averaging based on the window size. The long term averaging is used for setting the adaptive RF power threshold level. The short term averaging value, on the other hand, is compared with the long term averaging value to check for the good signal level. After locking to the desired satellite, the homing control system performs a fine tuning to maximize the received RF power as much as possible.

In order to compensate for the vehicle movement in homing mode, the azimuth gyro control loop is activated during this mode. This helps the system find the desired satellite as fast as possible at all times during which the vehicle is moving.

In step (b), the system continuously tracks the satellite by a hybrid control loop, using the information provided by gyros and performing the electronic beam-forming. This step comprises (b-1) providing an open-loop control based on the rate sensors and (b-2) providing a closed-loop control based on the received RF signal level. Step (b-2) comprises the zero-knowledge electronic beam-forming, which compensates for the small vehicle movements and track the satellite while the azimuth and elevation changes occur within a predefined window. For large vehicle movements, however, a mechanical control loop (step (b-1)) is needed to point the antenna towards the desired satellite and keep the antenna position inside the window for which the electronic beam-forming is effective.

The step (b-1) is performed by two methods, either of which may be adopted. The first method provides a Proportional-Derivative (PD) control loop, comprising steps of (i) reading and integrating the rate sensor output, (ii) calculating the antenna position error by comparing the integrated output of the rate sensor with the desired position of antenna, set by homing in step (a), (iii) creating an PD acceleration signal based on the antenna position error, (iv) limiting the acceleration signal by a hard-limiter, (v) converting the hard-limited acceleration signal to an angular speed by passing it through a non-linear control logic, and (vi) applying angular speed to the step-motor by taking into account the gearing ratio.

The second method, which is alternative to the first method, provides a Multi Layer Proportional-Integral-Derivative (PID) control loop, comprising steps of (i) reading and integrating the rate sensor output, (ii) calculating the antenna position error by comparing the integrated output of the rate sensor with the desired position of antenna, set by homing in step (a), (iii) creating a PID position signal based on the antenna position error, and (vi) applying position signal to the step-motor. In this PID control loop, the integral and derivative gains are fixed while the proportional gain adaptively varies based on the antenna position feedback.

In order to eliminate effects of gyro drift and the high level noise associated with rate gyros a cascaded processing comprising of two mechanisms is devised. The first mechanism comprises a moving average window which updates the gyro null value every N samples. The new gyro null is compared to a so called base gyro null which is a direct function of the ambient temperature. If the difference is less than a predefined threshold, then the recently computed gyro null is used in the step (b-1). The next mechanism continuously monitors the gyro signal readings and also the azimuth/elevation angle to determine if the current antenna's attitude is just a random walk or a result of the vehicle real motion. In the case of random walk, the mechanism triggers a flag for the controller loop preventing any action to be performed. In this way, the control loop performs smoothly and chattering of the stepper motor around the desired azimuth/elevation is significantly reduced. The outcome of this layer (flag status) is also fed back to the first one serving as an additional decision making measure to update the gyro null value.

Electronic beam-forming is an essential part of the control loop in both homing and tracking modes. To implement this technique prior knowledge of the phase-voltage characteristics of the phase shifters is required. As these characteristics are device dependent and they may change with the environmental conditions, like temperature and humidity, as well as aging, a non-model based algorithm for the beam-forming is required. To this end, an innovative beam-forming technique is devised which does not require the system model parameters in general. This technique referred to as the zero-knowledge beam-forming.

The step (b-2) is performed by two methods, either of which may be adopted. Both methods use a gradient search algorithm to set the control voltages of the phase shifters in such a way that the received signal from the satellite is maximized. This is a signal processing problem which deals with maximizing the received power from a target with unknown Direction of Arrival (DOA). This problem can be solved using gradient based optimization techniques which require an estimation of the array correlation matrix. Estimating the correlation matrix may require the signals from all antenna arrays, which are accessible when we deal with the base-band processing. However, in the case when a combined signal from all antenna arrays is the only source, the problem becomes more complicated. To solve this problem we resort to the perturbation methods in order to estimate the gradient from the combined RF received signal.

The first method uses the stochastic approximation and finite-difference (FD) technique in order to estimate the gradient vector while the second one uses the Simultaneous Perturbation Stochastic Approximation (SPSA) technique. A more detailed description of these methods will be provided in the Detailed Description of the Preferred Embodiment.

Pertained to the step (b-2) are Direction Finding Techniques. As mentioned before, for small vehicle movements the tracking of the satellite is performed by electronic beam-forming. While forming the beam, the direction of the vehicle movement is estimated using the information provided by the phase-shifters control voltages. Based on the estimated direction the step motors are commanded to move accordingly and compensate the vehicle movement. The whole procedure helps the system have a broadside beam and maximize the received power. The direction finding techniques are performed by two methods, either of which may be adopted. In the first method the control voltages of a subset of phase-shifters are monitored. Based on these voltages the direction is estimated employing a set of rules. The second method for direction estimation is devised based on comparing the phase changes of some of the phase-shifters. A more detailed description of these methods will be provided in the Detailed Description of the Preferred Embodiment.

In step (c) is performed when the system temporarily loses the satellite during the tracking mode. This loss may occur due to the temporary blockage of the satellite signal (e.g., when the vehicle crosses under bridges or is shadowed by tall, overhanging trees). Upon losing the satellite, the control system sets a timer and monitors it for a time out. To compensate for the vehicle movements during the signal blockage the system continues the tracking mode until the timer expires. After time out the control system returns to the homing mode for a new acquisition process.

In step (d) a periodic calibration process runs in parallel with the tracking mode to update and calibrate the system parameters during the system operation. This calibration process compensates the parameter variations due to different environmental conditions. Because the electronic beam-forming is performed with zero knowledge, the calibration process is crucial to the proper operation.

### BRIEF DESCRIPTION OF THE DRAWINGS

FIG. 1 shows the basic configuration of the phased-array antenna to which the present invention is applied;

FIG. 2 is the general flow graph of the hybrid control system;

FIG. 3 is the flow graph of the first gyro control loop;

FIG. 4 is the flow graph of the second gyro control loop;

FIG. 5 is a phased-array structure according to the present invention; and

FIG. 6 is an exemplary set of rules for the second direction finding method.

### DETAILED DESCRIPTION OF A PREFERRED EMBODIMENT

Hereinafter, a detailed description of the preferred embodiments will be made with reference to the accompanying drawings.

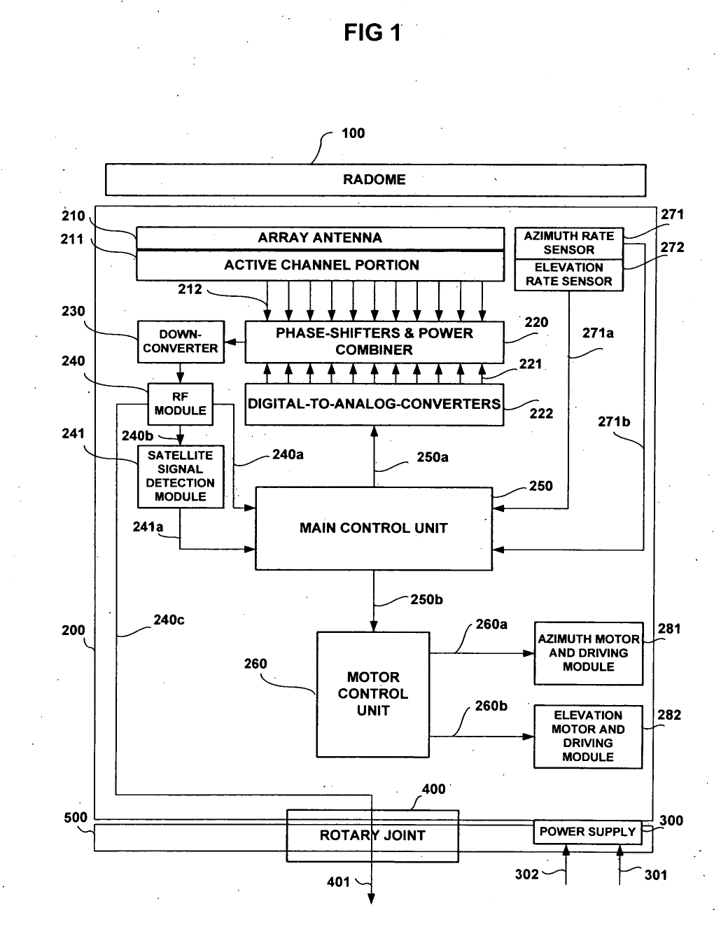

FIG. 1 is a block diagram of the phased-array antenna system to which the present invention is applied. Referring to FIG. 1, the phased-array antenna system comprises a radom 100, a rotating part 200 for receiving the satellite signals while rotating for satellite tracking, and fixed part 500 connected to the rotating part by a rotary joint 400, for supporting the rotating part and providing the power supply 300. The signal from the satellite is received by N antenna arrangements 210, passes through N active channel modules 211 for performing low noise amplification and connected by N cables 212 to N analog voltage controlled phase-shifter modules 220, for shifting the received signal to a desired phase. The N phase-shifted signals then are combined in a power combiner circuit 220 and down-converted to a desired intermediate frequency by a down-converter module 230. The down-converted signal passed to the RF module 240, and its power is detected by an RF detector, digitized (240a) and send to the main control unit 250, where the hybrid tracking algorithm is executed. RF module 240 also provides the signal 240c to the TV receiver through the rotary joint 400, and a signal path to the satellite signal detection module 241, in which the satellite ID 241a, is extracted and sent to the main control unit 250.

The antenna arrangements 210 are mounted on carriages and rotate along their traversal axes by the elevation motor 281, to allow the elevation angle change. The rotation of the antenna arrangement 210 in the azimuth plane is realized by rotating the rotating part 200 by the azimuth motor 282. The command for the azimuth motor 260a and the command for the elevation motor 260b are provided by the motor control unit 260. The phased-array antenna elements are connected to the low noise amplifiers (active channel modules). The active channel modules are connected to the variable phase shifters by cables (a plurality of connecting means). The outputs of the phase shifters are then combined by a power combiner and the combined signal is down-converted and passed to the RF detector module (signal detection). The output of the signal detector is used by the zero-knowledge algorithm (implemented in the main control board) to set the voltages of the phase shifters in such a manner as to maximize the RF signal power.

Referring to FIG. 1 again, the azimuth rate sensor 271 and the elevation rate sensor 272 provide azimuth angular rate and elevation angular rate of the antenna arrangements rotating part. The azimuth angular rate signal 271a and the elevation angular rate signal 271b are passed to the main control unit 250. Based on the inputs from the rate sensors 271a,b and RF module 240a the main control unit 250 performs the hybrid control algorithm and send control commands to the motor control unit 260 via 250b connection and to the digital-to-analog converters unit 222 via 250a connection. The digital commands, received from the main control unit are converted to the analog signals 221 and passed the phase-shifter & power combiner module 220, to control the phases of the phase-shifters.

The outputs of the phase shifters are combined by a power combiner and the combined signal is down-converted to a desired intermediate frequency (IF). The IF signal is passed to the RF detector module (for monitoring the signal power) and to the satellite ID extraction board (for extracting the satellite ID). The RF signal level and the extracted satellite ID are then passed to the main control unit where the zero-knowledge beam-forming algorithm along with the mechanical control loop is implemented. The angular rate sensors are connected to the main control unit as well, to provide the required information about the angular rates in azimuth and elevation directions. The main control unit is connected to the motor control unit for providing the proper commands to step motors via motor driver units. The main control unit is also connected to the plurality of digital-to-analog converters for providing the analog control voltages to phase-shifters.

In FIG. 1 the power supply unit 300 receives the vehicle's electric power (301 302) and applies it to the rotating part via power brushes.

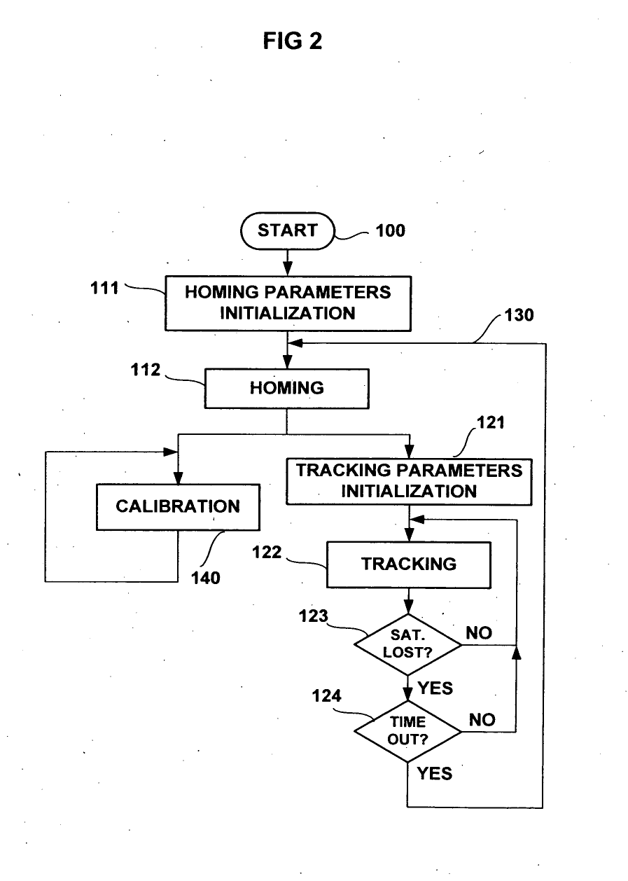

Turning now to FIG. 2, there is shown a general flow graph of the hybrid control system. Upon switching on the antenna system 100, the control system starts initializing the Homing parameters 111, and then enters to the Homing mode 112. In this mode the antenna platform performs an initial satellite search using combined mechanical and electronic techniques. When the RF power exceeds a threshold level the Satellite ID is then obtained from the based-band DVB signal. The threshold level is determined adaptively in the course of system operation. Once the extracted ID coincides with the desired satellite ID, then the homing process is completed and the control system enters the tracking mode. The tracking mode starts with the tracking parameters initialization 121. After the tracking parameters being initialized, the system starts the tracking 122 using a hybrid control loop until it temporarily loses the satellite 123. Upon losing the satellite, the control system sets a timer and monitors it for a time out 124. After time out the control system returns to the homing mode 130 for a new acquisition process.

Further, in FIG. 2 a periodic calibration process 140 is shown which runs in parallel with the tracking mode to update and calibrate the system parameters during the system operation.

Electronic beam-forming is an essential part of the control loop in both homing and tracking modes. To implement this technique prior knowledge of the phase-voltage characteristics of the phase shifters 220 is required. As these characteristics are device dependent and they may change with the environmental conditions, like temperature and humidity, as well as aging, a non-model based algorithm for the beam-forming is required. To this end, an innovative beam-forming technique is devised which does not require the system model parameters in general. This technique is referred to as the zero-knowledge beam-forming.

The goal of beam-forming is to set the control voltages of the phase-shifters in such a way that the received signal from the satellite is maximized. This problem can be solved using gradient based optimization techniques which require an estimation of the array correlation matrix. To estimate the correlation matrix the signals from all antenna arrays may be required, which are accessible the base-band processing is employed. However, in the case when a combined signal from all antenna arrays is the only source, the problem becomes more complicated. To solve this problem we resort to the perturbation methods in order to estimate the gradient from the combined RF received signal. In the following the methods which are used in the zero-knowledge beam-forming algorithm are described.

Let s(n)=[s₁(n),s₂(n), . . . ,s_{N}(n)] and w(n)=[w₁(n),w₂(n), . . . ,w_{N}(n)] denote the impinged power from the target to the array elements 210 and the phase-shifts applied to each antenna element at time instant n, then the total signal after the power combiner can be written as

f(n)=w*(n)s^{T}(n) (1)

where * and ^{T} denote the complex conjugate and transpose operations, respectively. The measured RF power at the output of the RF detector is

P(n)=E[f(n)·f*(n)] (2)

where E[.] denotes the expectation operation. Note that P(n) is a function of the phase shifts applied to each antenna element, i.e. w(n)=[w₁,w ₂, . . . ,w_{N}]. These phase shifts are controlled by a set of control voltages which can be shown by a 1×N vector as v(n)=[v₁,v₂, . . . ,v_{N}]. This implies the dependence of the RF power on the control voltages.

To maximize the RF power a Least Mean Square (LMS) can be employed. In this method, however, a direct unbiased measurement of the gradient,g(v)=∇P, is required. As mentioned before the only source of the received information is the RF signal power, from which the gradient cannot be measured directly. Hence, we explore the stochastic approximation and the finite-difference (FD) method in order to estimate the gradient vector,g, based on a noisy measurement of the RF signal power. Based on this method the recursive zero-knowledge beam-forming algorithm can be formulated as

v(n+1)=v(n)+2μĝ(n) (3)

where μ is a positive scalar indicating the step size which controls the convergence rate, ĝ(n)=[ĝ₁(n),ĝ₂(n), . . . ,ĝ_{N}(n)] is the estimated gradient vector, and n shows the discrete time index. Using a two-sided Finite Difference (2-FD) technique, the ith element of the estimated gradient vector is calculated as

$${\hat{g}}_{i} ( n ) \approx \frac{P ( {v}_{i} ( n ) + δ ) - P ( {v}_{i} ( n ) - δ )}{2 δ} \qquad ( 4 )$$

In (3), δ denotes the perturbation applied to each element to find the finite difference approximation of the derivative.

The gradient vector can also be estimated using a one-sided Finite Difference (1-FD) technique wherein is ith element is calculated with the following equation

$${\hat{g}}_{i} ( n ) \approx \frac{P ( {v}_{i} ( n ) + δ ) - P ( {v}_{i} ( n ) )}{δ} \qquad ( 5 )$$

The 1-FD method needs less RF signal power at the expense of a slight performance degradation.

To obtain the gradient estimate using 2-FD or 1-FD techniques 2N+1or N+1 signal power measurements are required to update one set of voltages. To decrease the amount of measurements, which are time consuming, another method of estimating the gradient, namely Simultaneous Perturbation Stochastic Approximation (SPSA) is employed. In this approach, the gradient is estimated by perturbing the control voltage vector simultaneously by a random vector. This method can be formulated as

$$\hat{g} ( n ) \approx {\frac{\begin{matrix}P ( v ( n ) + c ( n ) \cdot Δ ( n ) ) - \\ P ( v ( n ) - c ( n ) \cdot Δ ( n ) )\end{matrix}}{2 c ( n )} [ {Δ}_{1}^{- 1} ( n ) , {Δ}_{2}^{- 1} ( n ) , … , {Δ}_{N}^{- 1} ( n ) ]}^{T} \qquad ( 6 )$$

where c(n) is a constant which can be fixed or adaptively chosen based on a performance measure. In (5), Δ(n)=[Δ₁(n),Δ₂(n), . . . ,Δ_{N}(n)]^{T} is a vector with elements chosen from a Bernoulli distributed random source with p=0.5, i.e.

$${Δ}_{i} ( n ) = \{ \begin{matrix}+ 1 & p = 0.5 \\ - 1 & 1 - p = 0.5\end{matrix} \qquad ( 7 )$$

Setting the proper values for the beam-forming algorithm parameters, μ and c will affect accuracy and convergence rate.

The SPSA technique requires less RF measurement per iteration. Note that at each iteration, only two RF measurements are needed to calculate the gradient. Although this causes the algorithm performs faster, however, its low convergence rate makes the total settling time comparable to that of the FD methods.

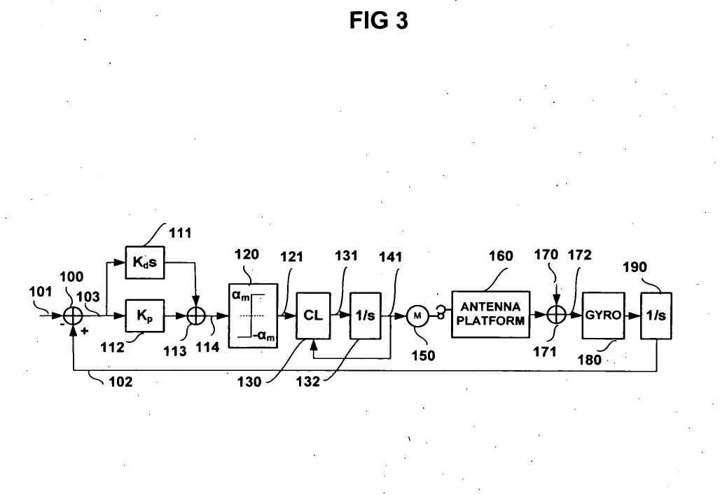

Turning now to FIG. 3, there is shown a flow graph of the first gyro control loop method comprising; the desired position of the antenna 101, the antenna position feedback 102, the antenna position error 103, PD control units 111, 112 with PD control parameters, k_{d}, kₚ, a hard-limiter 120, a control logic 130 and integrator 132, the azimuth or elevation motor 150, the antenna platform 160, a rate gyro 180, and an integrator 190.

The desired position of the antenna 101 is set by the homing and fine tuning, performed by the electronic beam-forming. Based on the antenna position error the PD control outputs an acceleration signal 114. This acceleration is limited by a hard-limiter 120 and the hard-limiter output (v₁) 121, is then applied to a Control Logic (CL) unit 130. The CL output (v₂) 131 is integrated by the integrator unit 132. The operation of the CL unit 131 is formulized as below.

if (|ωₛₘ| > K_{ω} & & sgn(ωₛₘ) = sgn(ν1))

then ν₂=0

else

then ν₂= ν₁

where K_{ω} is a constant, obtained experimentally.

Integrating the acceleration signal (v₂) 131 the angular speed (ωₛₘ) 141 is calculated and applied to the step motor 150. This angular speed translates to the angular speed of the platform 170 by taking into account the gearing ratio. The rate gyro 180 senses the resultant angular speed 172 of the antenna platform and the disturbance applied to the antenna base by the vehicle movement 170. An integrator 190 provides a position signal 102 from the resultant angular speed and feeds back it to the input.

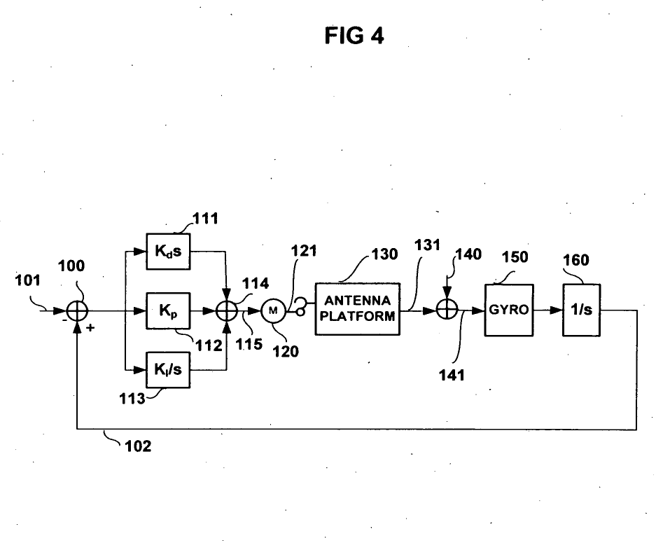

The second control loop is a multi-layer PID. The flow graph of the second control loop is shown in FIG. 4. This loop comprises: the desired position of the antenna 101, the antenna position feedback 102, the antenna position error 103, PID control units 111, 112, 113 with PID control parameters k_{d}, kₚ, k₁, the azimuth or elevation motor 120, the antenna platform 130, a rate gyro 150, and an integrator 160.

As the first control loop, the desired antenna position 101 is set by the homing and electronic beam-forming. The PID control parameters, k_{d} and k₁ are optimized for the best performance. These parameters are fixed and do not vary during the operation of the system. However, the parameter kₚ adaptively varies based on the antenna position feedback (θ_{af}) 102. The rules for setting kₚ are formulized as bellow.

if (|θ_{af}| ≧ L₁)

then kₚ=0

else if (L₂ ≧ θ_{af} > L₁)

then kₚ= kₚ₁

else if (θ_{af} > L₂)

then kₚ= kₚ₂

else if (−L₂ ≦ θ_{af} < −L₁)

then kₚ=− kₚ₁

else

then kₚ=− kₚ₂

The values of kₚ₁ and kₚ₂ are obtained experimentally by optimizing the performance.

As mentioned before, for small vehicle movements the tracking of the satellite is performed by electronic beam-forming. While forming the beam, the direction of the vehicle movement is estimated using the information provided by the phase-shifters control voltages. Based on the estimated direction the step motor is commanded to move accordingly and compensate the vehicle movement. The whole procedure helps the system have a broadside beam and maximize the received power. To this end two methods are developed.

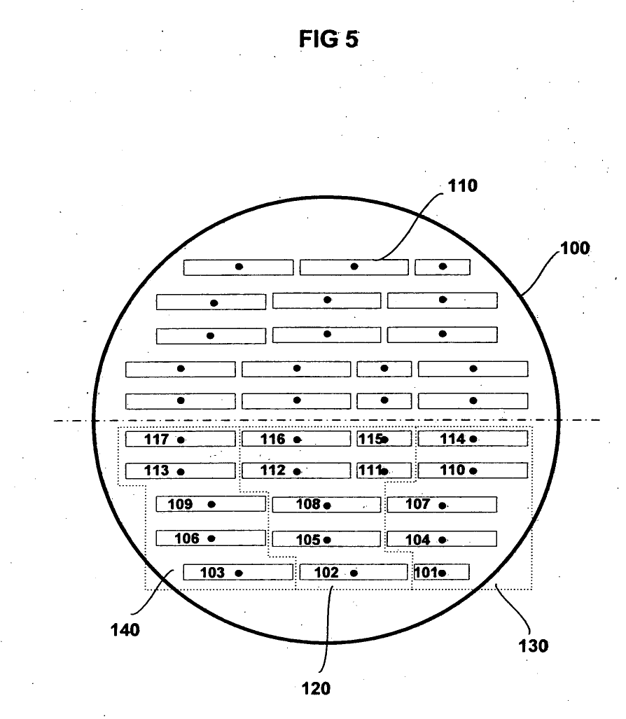

FIG. 5 shows the phased-array antenna system 100 with the sub-arrays 110 numbered for future reference. The half part of the antenna system may be used for Right Hand (RH) circular polarization while the other half part may be used for the Left Hand (LH) one. We consider only one half part to describe the method.

As per previous discussion, during the fine tuning the electronic beam-forming directs the phased-array antenna beam towards the satellite. Based on the vehicle movement, the direction of the beam may not coincide with the antenna broadside pointing direction. Monitoring the values of the phase-shifters control voltages is a way to estimate the direction which antenna should rotate in order to get the maximum RF power in the broadside.

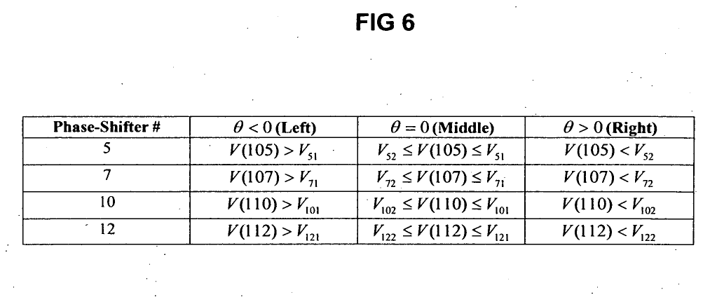

As a first method of direction finding, the control voltages of a subset of phase-shifters are monitored. Based on these voltages the direction is estimated employing some rules. As an example, the rules based on monitoring the control voltages of 4 elements are shown in FIG. 6. These rules specify which direction the antenna system should rotate in order to make the main lobe of the antenna perpendicular to antenna elements surface.

The variables V(j), j=105,107,110, and 112 show the control voltages of the phase-shifters corresponding to the sub-array 105, 107, 110 and 112, shown in FIG. 5. The threshold parameters (Vⱼ₁,Vⱼ₂), j=105,107,110, and 112 are determined experimentally by optimizing the performance.

The second method for direction estimation is devised based on comparing the phase changes of the left and right phase shifters corresponding to the left 130 and right 140 located sub-arrays shown in FIG. 5.

The control voltages of the phase-shifters are assumed to be known for a broadside beam. In fact these voltages can be obtained and updated during the calibration process. Denoting these voltages with v_{M}=[V_{M}(101),V_{M}(102), . . . ,V_{M}(117)], the direction estimating algorithm can be formulated as below.

for j=101,104,107,110,114

{ if (V(j) > V_{M} (j) + V_{mgn})

then increment Left_Counter

else if (V(j) < V_{M} (j) − V_{mgn})

then increment Right_Counter

else

then increment Middle_Counter

}

for j=103,106,109,113,117

{ if (V(j) < V_{M} (j) − V_{mgn})

then increment Left_Counter

else if (V(j) > V_{M} (j) + V_{mgn})

then increment Right_Counter

else

then increment Middle_Counter

}

if (Left_counter ≧6)

then θ < 0 (Left)

else if (Right_counter ≧6)

then θ > 0 (Right)

else

then θ = 0 (Middle)

In the above algorithm the parameter V_{mgn} is a margin voltage that is determined experimentally.

The experimental results show that both methods are effective in tracking the small vehicle movements. As these algorithms are not sensitive to the exact phase-voltage relationship of the phase-shifters, they are reliable and can work in different environmental conditions.

We claim:

1. A method of beam-forming for a tracking phased-array antenna system mounted on a mobile platform for use in tracking a target, said system having a plurality of array elements connected to a plurality of active channel modules, the channel modules being connected to a plurality of variable phase shifters, the phase shifters having outputs and the outputs being combined by a power combiner circuit and passed to a signal level detector, said method comprising using an algorithm to maximize a level of a signal received from said target without prior knowledge of the characteristics of the phase shifters or paths thereof.

2. A method as claimed in claim 1, including the steps of:
(a) measuring the received RF power, P(n), in the time instant n
(b) applying the two sided finite-difference (2-FD) method in order to estimate the gradient of RF power signal with the following equation:
$${\hat{g}}_{i} ( n ) \approx \frac{P ( {v}_{i} ( n ) + δ ) - P ( {v}_{i} ( n ) - δ )}{2 δ}$$
where δ denotes the 2-FD parameter, vᵢ(n) is the control voltage of the ith phase-shifter at time instant n, and ĝᵢ(n) is the ith component of the gradient vector at time instant n,
(c) updating the control voltage in a recursive manner with the following equation:
v(n+1)=v(n)+2μĝ(n)
where v(n)=[v₁,v₂, . . . ,v_{N}] is the set of control voltages of the phase-shifters at time instant n, ĝ(n)=[ĝ₁(n),ĝ₂(n), . . . ,ĝ_{N}(n)] is the estimated gradient vector at time instant n, and μ is the step size parameter; and
(d) repeating steps (a), (b), and (c) for a preset number of iterations.

3. A method as claimed in claim 1, including the steps of
(a) measuring the received RF power, P(n), in the time instant n
(b) applying the one sided finite-difference (1-FD) +method in order to estimate the gradient of RF power signal with the following equation:
$${\hat{g}}_{i} ( n ) \approx \frac{P ( {v}_{i} ( n ) + δ ) - P ( {v}_{i} ( n ) )}{δ}$$
where δ denotes the 1-FD parameter, vᵢ(n) is the control voltage of the ith phase-shifter at time instant n, and ĝᵢ(n) is the ith component of the gradient vector at time instant n,
(c) updating the control voltage in a recursive manner with the following equation:
v(n+1)=v(n)+2μĝ(n)
where v(n)=[v₁,v₂, . . . ,v_{N}] is the set of control voltages of the phase-shifters at time instant n, ĝ(n)=[ĝ₁(n),ĝ₂(n), . . . ,ĝ_{N}(n)] is the estimated gradient vector at time instant n, and μ is the step size parameter; and
(d) repeating steps (a), (b), and (c) for a preset number of iterations.

4. A method as claimed in claim 1, including the steps of
(a) measuring the received RF power, P(n), in the time instant n
(b) applying the Simultaneous Perturbation Stochastic Approximation method in order to estimate the gradient of RF power signal with the following equation:
$$\hat{g} ( n ) \approx {\frac{\begin{matrix}P ( v ( n ) + c ( n ) \cdot Δ ( n ) ) - \\ P ( v ( n ) - c ( n ) \cdot Δ ( n ) )\end{matrix}}{2 c ( n )} [ {Δ}_{1}^{- 1} ( n ) , {Δ}_{2}^{- 1} ( n ) , … , {Δ}_{N}^{- 1} ( n ) ]}^{T}$$
where v(n)=[v₁,v₂, . . . ,v_{N}] is the set of control voltages of the phase-shifters at time instant n, ĝn=[ĝ₁(n),ĝ₂(n), . . . ,ĝ_{N}(n)] is the estimated gradient vector at time instant n, Δ(n)=[Δ₁(n),Δ₂(n), . . . ,Δ_{N}(n)]^{T} is a vector with elements chosen from a Bernoulli distributed random source with p=0.5, c(n) is a constant which can be fixed or adaptively chosen based on a performance measure,
(c) updating the control voltage in a recursive manner with the following equation:
v(n+1)=v(n)+2μĝ(n)
where v(n)=[v₁,v₂, . . . ,v_{N}] is the set of control voltages of the phase-shifters at time instant n, ĝ(n)=[ĝ₁(n),ĝ₂(n), . . . ,ĝ_{N}(n)] is the estimated gradient vector at time instant n, and μ is the step size parameter; and
(d) repeating steps (a), (b), and (c) for a preset number of iterations.

5. A method of beam-forming for a tracking phased-array antenna system mounted on a mobile platform for use in tracking a target, said system having a plurality of array elements connected to a plurality of active channel modules, the channel modules being connected to a plurality of variable phase shifters, the phase shifters having outputs and the outputs being combined by a power combiner circuit and passed to a signal level detector, said method comprising activating said system and initializing a homing process to locate said target from a signal received from said target, performing hybrid tracking after the homing process is completed, repeating the homing process if the target is lost to relocate the targets said homing process using an antenna that performs combined mechanical and electronic techniques.

6. A method as claimed in claim 5, including the steps of performing periodic calibration for updating parameters and compensating the parameter variation due to environmental conditions and aging.

7. A method as claimed in claim 6, including the steps oft in the homing process, commencing with a preset setting for the phase shifters obtained from the calibration and history of the system, including the initial values for control voltages of the phase shifters, using step motors to perform the mechanical search for the target in both azimuth and elevation directions.

8. A method as claimed in claim 7, including the steps of exceeding a RF power threshold, having a control system extract an ID for the target and compare it with a predetermined target ID).

9. A method as claimed in claim 8, including the steps of setting the RF power threshold adaptively by performing moving averaging for the signal power with two different averaging window sizes, using short term averaging and long term averaging based on the window size.

10. A method as claimed in claim 9, including the steps of using the long term averaging to set the adaptive RF power threshold and using the short term averaging to compare with the long term averaging to check for a good signal level.

11. A method as claimed in claim 10, including the step of after locking to the target, having the control system perform fine-tuning to maximize the received RF power.

12. A method as claimed in claim 11, wherein the system has a hybrid control loop, including the step of activating the control loop to compensate for movement of the mobile platform in order to find the desired target as quickly as possible while the platform is moving, using information provided by gyros and performing the beam forming by providing an open-loop control based on rate sensors and providing a closed-loop control based on the received RF signal with zero-knowledge electronic beam forming and using a mechanical control loop to physically point the antenna toward the desired target for large vehicle movements.

13. A method as claimed in claim 12, including the step of providing the open-loop control based on rate sensors by providing a proportional-derivative control loop comprising steps of reading and integrating a rate sensor output and calculating an antenna position error by comparing the integrated output of the rate sensor with the desired position of the antenna, creating a proportional derivative acceleration signal based on the antenna position error, limiting the acceleration signal by a hard limiter, converting the hard-limited acceleration signal to an angular speed by passing it through a non-linear control logic and applying angular speed to the step motor by taking into account the gearing ratio.

14. A method as claimed in claim 12, including the steps of providing a multi-layer proportional integral derivative control loop comprising steps of reading and integrating the rate sensor output, calculating the antenna position error by comparing the integrated output of the rate sensor with the desired position of antennae set by the homing process, creating a proportional integral derivative positions signal based on the antenna position error and applying the position signal to the step motor.

15. A method as claimed in claim 5, including the steps of using an algorithm to maximize a level of signal received from said target with zero knowledge of the phase shifters.

16. A method as claimed in claim 2, including the step of adaptively choosing the step size parameter according to a displacement of the array.

17. A method as claimed in claim 3, including the step of adaptively choosing the step size parameter according to a displacement of the array.

18. A method as claimed in claim 4, including the step of adaptively choosing the step size parameter according to a displacement of the array.

19. A tracking phased-array antenna system mounted on a mobile platform for tracking a target, said system comprising:
(a) a plurality of array antennae for receiving a signal from a target;
(b) a plurality of phase shifters for shifting the signal received from the target to a desired phase;
(c) a power combiner circuit to combine output signals of said phase shifters;
(d) a converter for down-converting a combined received signal to a desired intermediate frequency;
(e) a target signal detection module for extracting an ID of the target;
(f) a RF module for monitoring the received signal and providing a signal path to a target signal detection module;
(g) said array antennae being mounted to rotate in azimuth and elevation directions;
(h) a main control unit controlled by hybrid tracking control algorithms; and
(i) a plurality of digital-to-analog converters for providing analog control voltages to phase shifters.

20. A tracking phased-array antenna system as claimed in claim 19, wherein said plurality of array antennae are capable of transmitting a signal to said target.

21. A tracking phased-array antenna system as claimed in claim 20, wherein said plurality of phase shifters are analog voltage controlled phase shifters.

22. A tracking phased-array antenna system as claimed in claim 20, wherein there are a plurality of active channel modules for performing low noise amplification, followed by a plurality of connecting means.

23. A tracking phased-array antenna system as claimed in claim 20, wherein there are step motors for rotating a portion of said array antennae with a motor control unit to control said step motors and motor drivers for driving said step motors.

24. A method of eliminating the effects of gyro drift and high level noise associated with rate gyros, said method comprising;
(a) updating a gyro null value every N samples using a moving average window and comparing a new gyro null to a base gyro null which is a direct function of ambient temperature;
(b) updating the gyro null value by a recently computed gyro null if a difference between the new gyro null and the base gyro null is less than a predefined threshold;
(c) continuously monitoring the gyro signal readings and the azimuth/elevation angle for determining if a current attitude of an antenna is a result of a random walk or real motion of a platform for the antenna;
(d) triggering a flag, in the ease of random walk, to prevent a controller loop from taking any action; and
(e) using a flag status as an additional decision making measure to update the gyro null value.

25. A method for electronic fine tuning of a tracking system, said method comprising basing the tracking system on monitoring values of control voltages of phase shifters and setting a rule to estimate a direction of vehicle movement.

26. A method as claimed in claim 25, including the step of comparing phase changes of a set of left phase shifters with phase changes of a set of right phase shifters.

27. A hybrid tracking algorithm comprising;
(a) a zero knowledge electronic beam forming method;
(b) a gyro loop control method;
(e) a direction finding method; and
(d) commanding a step motor to move in a direction estimated by monitoring the values of control voltages of the phase shifters and setting rule to estimate a direction of the vehicle movement and comparing the phase changes of a set of left phase shifters with a set of right phase shifters, and moving the step motor based on the difference between said phase shifters,

28. A hybrid tracking algorithm as claimed in claim 27, including the steps of;
(a) measuring the received RF power, P(n), in the time instant n;
(b) applying the two-sided finite-difference (2-FD) method in order to estimate the gradient of RF power signal with the following equation:
$${\hat{g}}_{i} ( n ) \approx \frac{P ( {v}_{i} ( n ) + δ ) - P ( {v}_{i} ( n ) - δ )}{2 δ}$$
where δ denotes the 2-FD parameter, vᵢ(n) is the control voltage of the ith phase-shifter at time instant n, and ĝᵢ(n) is the ith component of the gradient vector at time instant n;
(c) updating the control voltage in a recursive manner with the following equation;
v(n+1)=v(n)+2μĝ(n)
where v(n)=[v₁,v₂, . . . ,v_{N}] is the set of control voltages of the phase-shifters at time instant n, ĝ(n)=[ĝ₁(n),ĝ₂(n), . . . ,ĝ_{N}(n)] is the estimated gradient vector at time instant n, and μ is the step size parameter; and
(d) repeating steps (a), (b), and (c) for a preset number of iterations.

29. A hybrid tracking algorithm as claimed in claim 27, including the steps of:
(a) measuring the received RF power, P(n), in the time instant n;
(b) applying the one sided finite-difference (1-FD) method in order to estimate the gradient of RF power signal with the following equation:
$${\hat{g}}_{i} ( n ) \approx \frac{P ( {v}_{i} ( n ) + δ ) - P ( {v}_{i} ( n ) )}{δ}$$
where δ denotes the 1-FD parameter, vᵢ(n) is the control voltage of the ith phase-shifter at time instant n, and ĝᵢ(n) is the ith component of the gradient vector at time instant n;
(c) updating the control voltage in a recursive manner with the following equation:
v(n+1)=v(n)+2μĝ(n)
where v(n)[v₁,v₁, . . . ,v_{N}] is the set of control voltages of the phase-shifters at time instant n, ĝ(n)=[ĝ₁(n),ĝ₂(n), . . . ,ĝ_{N}(n)] is the estimated gradient vector at time instant n, and μ is the step size parameter, and
(d) repeating steps (a), (b), and (c) for a preset number of iterations.

30. A hybrid tracking algorithm as claimed in claim 27, including the steps of
(a) measuring the received RF power, P(n), in the time instant n;
(b) applying the Simultaneous Perturbation Stochastic Approximation method in order to estimate the gradient of RF power signal with the following equation:
$$\hat{g} ( n ) \approx {\frac{\begin{matrix}P ( v ( n ) + c ( n ) \cdot Δ ( n ) ) - \\ P ( v ( n ) - c ( n ) \cdot Δ ( n ) )\end{matrix}}{2 c ( n )} [ {Δ}_{1}^{- 1} ( n ) , {Δ}_{2}^{- 1} ( n ) , … , {Δ}_{N}^{- 1} ( n ) ]}^{T}$$
where v(n)=[v₁,v₂, . . . ,v_{N}] is the set of control voltages of the phase-shifters at time instant n, ĝ(n)=[ĝ₁(n),ĝ₂(n), . . . ,ĝ_{N}(n)] is the estimated gradient vector at time instant n, Δ(n)=[Δ₁(n),Δ₂(n), . . . ,Δ_{N}(n)] is a vector with elements chosen from a Bernoulli distributed random source with p=0.5, c(n) is a constant which can be fixed or adaptively chosen based on a performance measure;
(c) updating the control voltage in a recursive manner with the following equation:
v(n+1)=v(n)+2μĝ(n)
where v(n)=[v₁,v₂, . . . ,v_{N}] is the set of control voltages of the phase-shifters at time instant n, ĝ(n)=[ĝ₁(n),ĝ₂(n), . . . ,ĝ(n)] is the estimated gradient vector at time instant n, and μ is the step size parameter; and
(d) repeating steps (a), (b), and (c) for a preset number of iterations.

31. A hybrid tracking algorithm as claimed in claim 27, including the steps of operating a PD control loop with an input position signal and controlling a speed of a step motor,
(a) a preset desired position of the antenna;
(b) PD control units, providing an acceleration signal from the weighted sum of the antenna position error and its derivative;
(c) a hard-limiter to limit the acceleration;
(d) a control logic;
(e) and integrator and a summer;
(f) the azimuth or elevation motor;
(g) the antenna platform;
(h) a rate gyro; and
(i) an integrator.

32. A hybrid tracking algorithm as claimed in claim 27, including the steps of using a multi-layer PID control loop operating with an input position signal and controlling the position of a step motor using;
(a) a preset desired position of the antenna;
(b) PID control units, providing an position signal from the weighted sum of the antenna position error, its derivative and its integration;
(c) the azimuth or elevation motor;
(d) the antenna platform;
(e) a rate gyro; and
(f) an integrator.
